(19) United States
(12) Patent Application Publication
(10) Pub. No.: US 2002/0174053 A1
(43) Pub. Date: Nov. 21, 2002

(54) Optimizing decision making

(76) Inventor: William Henry Tan, Austin, TX (US)

Correspondence Address: OLIFF & BERRIDGE, PLC, P.O. BOX 19928, ALEXANDRIA, VA, 22320, US

(21) Appl. No.: 09/859,495

(22) Filed: May 18, 2001

(51) Int. Cl. G06F 17/60

(52) U.S. Cl. 705/37; 705/10

(57) ABSTRACT

A method of optimizing decisions relating to trading in a commodity, includes the following steps:

(a) consumption data relating to consumption of the commodity by individual users is measured;

(b) the measured consumption data is stored in a computer database;

(c) forecasts for requirements of the commodity are determined using computers or other digital communications apparatus;

(d) the forecasts are transmitted to the computer database via a computer network;

(e) information relating to the market value of the commodity is transmitted to the computer database via the computer network; and

(f) the optimized profit for the commodity which is being traded is calculated based on the consumption data and the market value information.

### FIELD OF THE INVENTION

This invention relates to a method and system for optimizing decision making. It relates particularly but not exclusively to a method and system for optimizing decision making when trading in a commodity by considering the market value of the commodity in addition to the supply and demand of the commodity.

### BACKGROUND OF THE INVENTION

It is often necessary for commodity suppliers or resellers to be able to predict future demand for the commodity which they supply. If the supplier knows in advance how much of the commodity is required on any given day, the supplier can produce or purchase exactly the right amount of the commodity, resulting in reduced wastage, greater efficiencies in production, and reduced overheads.

Commodity traders in general are not able to bid for the exact amount of commodity resources needed by the trader's customers because it is not possible for a trader to be aware of all factors which may affect the customers'future individual requirements for the commodity.

At present, suppliers, resellers and traders typically rely on historical data to provide a forecast of future demand. For example, if the commodity is electricity, historical data for a particular group of consumers may indicate a seasonal increase in demand during winter. Historical data may also indicate a trend of a 5% increase per year in the usage of electricity by the group of consumers. Weather forecasts may indicate that the next winter is expected to be especially cold. Accordingly, the predicted demand amongst the group of consumers for electricity during the next winter will be the actual amount required last year, adjusted upwards by 5% to allow for the long-term trend, and adjusted upwards by a further amount to allow for increased demand attributable to the expected cold weather.

However, the supplier, reseller or trader cannot simply purchase or produce the exact amount of the commodity required to satisfy the predicted demand. In order to guard against the adverse consequences which arise If there is insufficient stock to meet demand, it is usually necessary to buy or produce enough of the commodity to provide a margin for error in case levels of demand exceed the forecasted levels.

Variations in demand can happen for a number of reasons. In the case of electricity supply to a group of consumers, the demand may be increase significantly if, for example, one member of the group operates a factory which consumes a lot of electricity, and the factory changes from a one-shift operation to a three-shift operation. Alternatively, demand may decrease significantly if some of the consumers replace electrical appliances with gas appliances.

Statistical analysis can be applied to fluctuations in demand over a period of time, and an appropriate safety level of commodity stock can be determined. However, statistical analysis does not cater for significant changes in demand brought about by one-off events, and a statistically-determined safety margin is still a relatively large one, resulting in considerable wastage of the commodity, and significant overhead costs to the supplier, reseller or trader.

In trading commodities, both the generation of, or supply of a commodity and the consumption of, or demand for a commodity influence the way in which that commodity will be traded. However, fluctuations of the market in which the commodity is traded also influence the way trades themselves are conducted. The dynamic fluctuations which occur across the three parameters: supply, demand and trade, make it difficult for traders in these commodities to ascertain optimal decisions for the conduct of their business.

An object of the present invention is to provide an improved method of optimising decisions which are made when trading in commodities.

### SUMMARY OF THE INVENTION

According to a first aspect of the invention, there is provided a method of optimizing decisions relating to trading in a commodity, including the following steps:

(a) consumption data relating to consumption of the commodity by individual users is measured;

(b) the measured consumption data is stored in a computer database;

(c) forecasts for requirements of the commodity are determined using computers or other digital communications apparatus;

(d) the forecasts are transmitted to the computer database via a computer network;

(e) information relating to the market value of the commodity is transmitted to the computer database via the computer network; and

(f) the optimized profit for the commodity which is being traded is calculated based on the consumption data and the market value information.

The consumption data may be measured in any suitable manner. In less sophisticated cases, the consumption data may be measured by measuring the amount of the commodity leaving the supplier's premises. In more sophisticated cases, consumption data is gathered by measuring the amount of the commodity supplied to individual consumers or groups of consumers or resellers. In an especially preferred case, the measured consumption data is measured by meters or sensors associated with individual users, and the data measured by the meters or sensors is transmitted to the computer database via the computer network. The computer database may be any suitable database using any suitable database software. The database may reside solely on one computer, or it may be distributed over two or more computers. Parts of the database may reside on individual users' computers, with other parts residing on database server.

Forecasts for requirements of the commodity can be determined in any suitable manner. In one arrangement, software operating on a user's computer presents the user with a form or template for entering and then posting the appropriate details. In an especially preferred arrangement, individual users are presented with personal consumption profiles based on measured consumption data relating to them, and they are requested to enter a personal forecast if they anticipate that their requirements for the commodity will deviate from their measured personal consumption profile.

In another preferred arrangement, forecasts for the consumption of a commodity are determined automatically. In one such case, a model of the user is constructed, the activities of which are determined using sensors which could be attached to the user or embedded in operating equipment. The consumption forecast is then obtained automatically by inference using the activities which are monitored, or using artificial intelligence technology.

Individual users may use any suitable computers or digital communications apparatus for entering personal forecasts for requirements of the commodity. Suitable digital communications apparatus Include Personal Digital Assistants such as PalmPilots™, mobile telephones, Wireless Application Protocol-enabled devices, and Web-enabled televisions.

The computer network may be any suitable computer network. It may be a local area network or, more preferably, a wide area network. More preferably still, the computer network is the Internet, and the database operates on an Internet database server.

Information relating to the market value of the commodity may be determined using the current unit price of the commodity. Alternatively, the market value of the commodity may be determined by considering the current unit price of the commodity, in addition to market conditions which include:

(a) risks associated with trading in the market;

(b) lateral agreements which exist between traders;

(c) weather conditions which affect the behaviour of the market;

(d) spot markets; and

(e) forward markets.

Decisions relating to optimized profit may be calculated using linear programming techniques or any other method which determines the optimised profit In terms of information relating to the market value of the commodity and the consumption data.

According to a second aspect of the invention, there is provided a method of optimizing decisions relating to supply of a commodity, including the following steps:

(a) consumption data relating to consumption of the commodity by individual users is measured;

(b) the measured consumption data is stored in a computer database;

(c) forecasts for requirements of the commodity are determined using computers or other digital communications apparatus;

(d) the forecasts are transmitted to the computer database via a computer network;

(e) information relating to the market value of the commodity is transmitted to the computer database via the computer network; and

(f) optimised supply conditions for the commodity are calculated based on the consumption data and the market value information.

Optimized decisions relating to supply of a commodity may be calculated using linear programming techniques or any other method which determines the optimized supply conditions in terms of information relating to the market value of the commodity and the consumption data.

According to a third aspect of the invention, there is provided a method of optimizing decisions relating to demand for a commodity, including the following steps:

(a) consumption data relating to consumption of the commodity by individual users is measured;

(b) the measured consumption data is stored in a computer database;

(c) forecasts for requirements of the commodity are determined using computers or other digital communications apparatus;

(d) the forecasts are transmitted to the computer database via a computer network;

(e) information relating to the market value of the commodity is transmitted to the computer database via the computer network; and

(f) optimised demand conditions for the commodity are calculated based on the consumption data and the market value information. Optimized decisions relating to demand for a commodity may be calculated using linear programming techniques of any other method which determines the optimized supply conditions in terms of information relating to the market value of the commodity and the consumption data.

The methods of the present invention are particularly useful for commodities traders who, in a deregulated commodities market must consider the effect that the market itself has on the trade price of the commodity, in addition to the balance between supply and demand.

The commodity to which the inventive methods relate may be any suitable commodity or commodities. In one embodiment of the invention, the commodity is a non-tangible commodity such as electricity, oil, gas, or communications bandwidth. In another embodiment of the invention, the commodity is a tangible commodity such as a type of food or a type of raw materials. In yet another embodiment of the invention, the commodity is a service such as a transportation service or a financial service.

It will be seen that the invention has applicability to a very broad range of different types of commodities. A single forecasting server located on the Internet can be used for forecasting the needs of groups of individuals for a number of different types of commodities.

According to a fourth aspect of the present invention, there is provided a system for optimizing decisions relating to supply of a commodity, demand for the commodity and trading in the commodity, the system including:

(a) measuring apparatus, for measuring data relating to consumption of the commodity by individual users;

(b) a market value data source, for providing market value data relating to the commodity;

(c) a computer database, for storing the consumption data and the market value data;

(d) a computer network, linking the market value data to the database;

(e) computer software for calculating forecasts of demand for the commodity based on the measured consumption data and the market value data; and

(f) software for optimizing decisions relating to supply of a commodity, demand for a commodity or trade in a commodity.

The measuring apparatus may be any suitable type of measuring apparatus. The suitability of the measuring apparatus depends upon the particular commodity being measured. The measuring apparatus may be located at the premises of the supplier, or at the premises of individual users or groups of users. In a preferred arrangement, the measuring apparatus consists of or includes meters or sensors associated with individual users.

The computer database may be any suitable database using any suitable database software. The database may reside solely on one computer, or it may be distributed over two or more computers. Parts of the database may reside on individual users' computers, with other parts residing on database server.

In one embodiment of the invention, forecasts are calculated using computer software. However, individual users may also enter personal forecasts for requirements of the commodity using computers or other digital communications apparatus. The computers or other digital communications apparatus associated with individual users may be of any suitable type. Suitable digital communications apparatus include Personal Digital Assistants such as PalmPilots™, mobile telephones, Wireless Application Protocol-enabled devices and Web-enabled televisions.

The computer network may be any suitable computer network. It may be a local area network or, more preferably a wide area network. More preferably still, the computer network is the Internet, and the database operates on an Internet database server.

It is preferred that the decision optimizing software uses systems which model the supply, demand and market of a commodity in order to calculate optimized profits. In one embodiment of the invention the decision optimizing software uses linear programming to optimize decisions relating to the supply of the commodity, demand for the commodity and trade in the commodity.

Preferably the system further includes user computer software running on computers or other digital communications apparatus associated with individual users, with forms or templates being displayed to users by the software, enabling the users to enter and then post the appropriate details for personal forecasts. It is further preferred that individual users are presented with personal consumption profiles based on measured consumption data relating to them, the user software enabling individual users to enter a personal forecast if they anticipate that their requirements for the commodity will devote from their measured personal consumption profile. Forecasts for the consumption of a commodity may also be determined automatically, wherein the user is modelled and the consumption is determined using activities which are monitored by sensors attached to the user or imbedded in operating equipment, or using artificial intelligence.

By accumulating together a number of forecasts, the system of the present invention allows a supplier, reseller or trader to obtain a forecast which, when used in conjunction with the optimized decisions enables the attainment of optimized profit, optimized supply and/or optimized demand of a commodity. This method is considerably more accurate than could be provided by considering historical data alone.

The close interactions which exist between the supply, demand and market models which can be used to represent a commodity result in heightened complexity in decision making, particularly which decisions are being made on a real-time basis. Using the present invention, an optimal decision which is calculated at any moment in time will benefit each of the three models such that optimal trading, optimal operations and optimal user management decisions are made. As a result of the complexity and extensive amount of data collection and comparison which is necessary, the use of computers is essential in optimizing decisions. It would not have been economically feasible to use the method of the present invention on a large scale without the use of computers.

In a preferred arrangement, the inventive system further includes a communications link to a commodity trader, enabling the commodity trader to use the forecasts of demand and the optimised decisions calculated by the decision optimizing software as a basis for bidding for the commodity in a commodities exchange.

### BRIEF DESCRIPTION OF THE DRAWINGS

The invention will hereinafter be described in greater detail by reference to the attached drawings which show an example form of the invention. It is to be understood that the particularity of the drawings does not supersede the generality of the preceding description of the invention.

FIG. 1 illustrates the integration between three models which can be used to define the constraints and resources which exist in the commodities market.

FIG. 2 is a schematic diagram illustrating one arrangement of components according to one embodiment of the present invention.

FIG. 3 is a flow diagram showing the steps involved in an embodiment of the inventive method.

FIG. 4 is an organizational chart which illustrates the three components which form the basis of the present invention.

### DETAILED DESCRIPTION

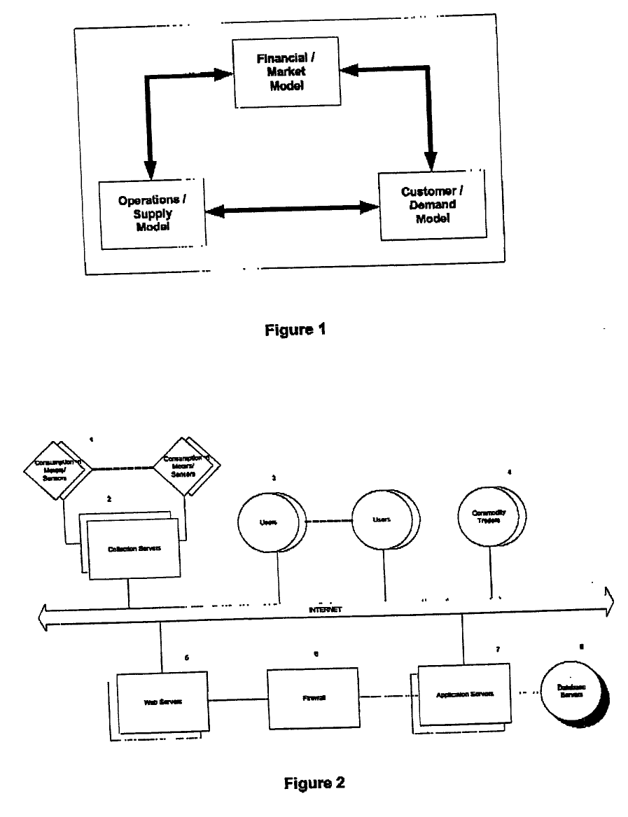

Referring firstly to FIG. 1, there is shown a commodity business integration model which illustrates the fundamental link between the “operations or supply” model, the “customer or demand model”, and the “financial or market model”. As parameters which determine the structure of one model vary, parameters in either or both of the other models vary in response. As a result of the dynamic fluctuation between these three models, it is difficult to determine decisions which are optimal in consideration of each of the three cases. The present invention alleviates this problem by constructing a utilization model which incorporates the “operations or supply” model, the “customer or demand” model and the “financial or market” model. It does this by defining available commodity resources, and the constraints which determine how the commodities are supplied, produced, consumed and traded. That is, as well as using the desired balance between supply and demand to optimize commodity trade decisions, the present invention incorporates the concept of competition in the commodity marketplace to enhance the decision-making process in relation to its supply and demand.

Referring now to FIG. 2, there is shown a system for forecasting the demand by a group of users for a commodity according to an embodiment of the invention. The system includes measuring apparatus 1, for measuring data relating to consumption of the commodity by individual users. Database servers 8 are for storing the consumption data. Computers or other digital communications apparatus 3 are associated with individual users, allowing individual users to enter personal forecasts for requirements of the commodity. A computer network, in this case the Internet, links the computers or other digital communications apparatus 3 associated with individual users to the database servers 8. The Internet can be TCP/IP Socket or Broadband based. Security for the whole infrastructure can be implemented using standard Internet solutions such as HTPS or SSL protocol.

In the particular embodiment illustrated In FIG. 1, real time user consumption data is collected by meters/sensors 1, and accumulated by collection servers 2. Measured data is forwarded to application servers 7 over the Internet.

Users log onto web servers 5 from their computers or other digital communications devices 3. Web servers 5 serve to the users pages which allow them to inspect their personal consumption profiles, which are based on the data measured by meters/sensors 1 and accumulated by collection servers 3. If a user anticipates a change in consumption, web servers 5 allow the user to enter details of the anticipated change in the user's personal demand. The data so collected directly from the user is posted to application servers 7 through firewall 6 (which protects against unauthorised access to application servers 7 and database servers 8). Data is stored permanently in database servers 8.

Application servers 7 calculate user profiles based on measured data, and forecasts based on individual user forecasts. Application servers 7 also compute optimization results which, in one embodiment of the invention, are calculated using linear programming. Commodity traders 4 can view the demand forecasts on web servers 5.

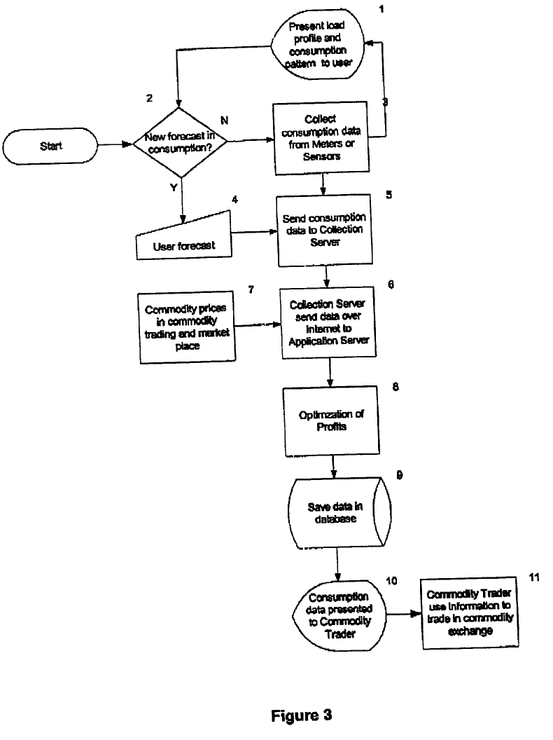

FIG. 3 shows a flow chart illustrating the steps involved in an embodiment of the inventive method. These steps are:

1. A user load profile and consumption pattern is displayed to the user in a web browser (or other display device).

2. The user views the load profile and decides whether a change in the forecast of demand for future supplies of the commodity is needed.

3. If there is no change in the forecast, the consumption meters and sensors continue to collect consumption information.

4. If there is a change in the forecast, the new forecast is fed to the Application server via the Web server.

5. The collection server collects data from the consumption meters/sensors.

6. The collection server, after making a local copy of the data, sends the data to the application server over the Internet.

7. The Application server is updated with commodity prices in a trading market.

8. The optimized profits of a trader in a commodity are determined by satisfying the constraints and resources which are described in the integrated “operations or supply”, “customer or demand” and “financial or market” models. It Is also desirable for the Application server to determine optimized supply and demand of the commodity by satisfying the constraints and resources of the integrated model.

9. The Application server saves a local copy of the data into the database server.

10. The Application server collates, validates and presents the data as meaningful information for display.

11. A commodity trader uses the real-time information provided by the system for bidding for the correct amount of the commodity needed by the users. A commodity supplier uses the real-time information provided by the system for supplying the correct amount of the commodity needed by the users. A commodity user uses the real-time information provided by the system in consuming the commodity.

Although a margin for safety in estimated demand may still be required, the method of the present invention substantially reduces the size of the required margin.

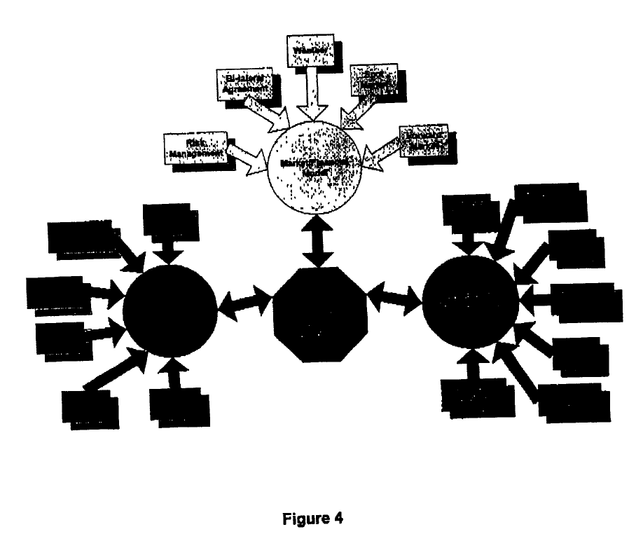

Referring finally to FIG. 4, a typical structure for an “operations or supply”, “customer or demand” and “financial or marker” model is illustrated. This covers aspects of the model which influence the interaction between the three arms of the structure, wherein the commodity being considered Is oil.

Issues affecting the “operations or supply” arm include: fuel type, uptime and downtime in manufacturing fuel cost, output on consumption (economy), power quality, and efficiency. Issues affecting the “financial or market” arm include: risk management, bi-lateral agreements between traders, weather influencing the marketplace, the spot market, and the forward market. Issues affecting the “customer or demand” arm include: demand forecasts, equipment efficiency, power quality, production run, pricing scheme, facility management and curtailment contracts.

It will be seen that the advantages provided by the preferred embodiment of the invention include the following:

1. The commodity trader can ensure optimized profits, the commodity supplier can ensure optimized supply and the commodity user can ensure optimized consumption by considering the constraints and resources which are described in the integrated “operations or supply”, “customer or demands” and “financial or market” model.

2. The commodity trader, suppliers and users are provided with accurate real-time data indicating the amounts of commodities being supplied, the amounts of commodities required by the users and the market behaviour of the commodity. This places the commodity trader in a sounder bargaining position.

3. Users are given detailed feedback concerning their own consumption patterns, allowing them to forecast more precisely their own requirements. It is to be understood that various alterations, additions and/or modifications may be made to the parts previously described without departing from the ambit of the present invention.

1. A method of optimizing decisions relating to trading in a commodity, including the following steps:
(a) consumption data relating to consumption of the commodity by individual users is measured;
(b) the measured consumption data is stored in a computer database;
(c) forecasts for requirements of the commodity are determined using computers or other digital communications apparatus;
(d) the forecasts are transmitted to the computer database via a computer network;
(e) information relating to the market value of the commodity is transmitted to the computer database via the computer network; and
(f) the optimized profit for the commodity which is being traded is calculated based on the consumption data and the market value infonnation.

2. A method according to claim 1 wherein the optimized decisions for trading in a commodity are determined using linear programming.

3. A method according to claim 1 wherein the measured consumption data is measured by meters or sensors associated with individual users, and the data measured by the meters or sensors is transmitted to the computer database via the computer network.

4. A method according to claim 1 wherein the commodity is a non-tangible commodity such as electricity, oil, gas, or communications bandwidth.

5. A method according to claim 1 wherein the commodity is a tangible commodity such as a type of food or a type of raw materials.

6. A method according to claim 1 wherein the commodity is a service such as a transportation service or a financial service.

7. A method of optimizing decisions relating to supply of a commodity, including the following steps:
(a) consumption data relating to consumption of the commodity by individual users is measured;
(b) the measured consumption data is stored in a computer database;
(c) forecasts for requirements of the commodity are determined using computers or other digital communications apparatus;
(d) the forecasts are transmitted to the computer database via a computer network;
(e) information relating to the market value of the commodity is transmitted to the computer database via the computer network: and
(f) optimized supply conditions for the commodity are calculated based on the consumption data and the market value information.

8. A method according to claim 8 wherein the optimized decisions relating to supply of a commodity are determined using linear programming.

9. A method according to claim 8 wherein the measured consumption data is measured by meters or sensors associated with individual users and the data measured by the meters or sensors is transmitted to the computer database via the computer network.

10. A method according to claim 8 wherein the commodity is a non-tangible commodity such as electricity, oil, gas, or communications bandwidth.

11. A method according to claim 8 wherein the commodity is a tangible commodity such as a type of food or a type of raw materials.

12. A method according to claim 8 wherein the commodity is a service such as a transportation service or a financial service.

13. A method of optimizing decisions relating to demand for a commodity, including the following steps:
(a) consumption data relating to consumption of the commodity by individual users is measured;
(b) the measured consumption data is stored in a computer database;
(c) forecasts for requirements of the commodity are determined using computers or other digital communications apparatus;
(d) the forecasts are transmitted to the computer database via a computer network;
(e) information relating to the market value of the commodity is transmitted to the computer database via the computer network; and
(f) optimised demand conditions for the commodity are calculated based on the consumption data and the market value information.

14. A method according to claim 13 wherein the optimized decisions relating to demand for a commodity are determined using linear programming.

15. A method according to claim 13 wherein the measured consumption data is measured by meters or sensors associated with individual users, and the data measured by the meters or sensors is transmitted to the computer database via the computer network.

16. A method according to claim 13 wherein the commodity is a non-tangible commodity such as electricity, oil, gas, or communications bandwidth.

17. A method according to claim 13 wherein the commodity is a tangible commodity such as a type of food or a type of raw materials.

18. A method according to claim 13 wherein the commodity is a service such as a transportation service or a financial service.

19. A system for optimizing decisions relating to supply of a commodity, demand for the commodity and trading in the commodity, the system including:
(a) measuring apparatus, for measuring data relating to consumption of the commodity by individual users;
(b) a market value data source, for providing market value data relating to the commodity;
(c) a computer database, for storing the consumption data and the market value data;
(d) a computer network, linking the market value data to the database;
(e) computer software for calculating forecasts of demand for the commodity based on the measured consumption data and the market value data; and
(f) software for optimizing decisions relating to supply of a commodity, demand for a commodity or trade in a commodity.

20. A system according to claim 19 wherein the software for optimizing decisions relating to supply of the commodity, demand for the commodity or trade in the commodity uses linear programming.

21. A system according to claim 19 wherein the measuring apparatus consists of or includes meters or sensors associated with individual users.

22. A system according to claim 19 wherein the computer network is the Internet, and the database operates on an Internet database server.

23. A system according to claim 19 further including user computer software running on computers or other digital communications apparatus associated with individual users, whereby individual users are presented with personal consumption profiles based on measured consumption data relating to them, the user software enabling individual users to enter a personal forecast if they anticipate that their requirements for the commodity will deviate from their measured personal consumption profile.

24. A system according to claim 19 further including a communications link to a commodity trader, enabling the commodity trader to use the optimized decisions as a basis for predicting future the supply of a commodity, the future demand for a commodity and future trading in the commodity.
